(19) United States
(12) Patent Application Publication
(10) Pub. No.: US 2010/0103313 A1
(43) Pub. Date: Apr. 29, 2010

(54) SIGNAL PROCESSOR AND SIGNAL PROCESSING METHOD

(75) Inventor: Shogo Matsubara, Tokyo (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Kabushiki Kaisha Toshiba, Tokyo (JP)

(21) Appl. No.: 12/430,769

(22) Filed: Apr. 27, 2009

(30) Foreign Application Priority Data
Oct. 23, 2008 (JP) 2008-273064

(51) Int. Cl. H04N 7/01

(52) U.S. Cl. 348/452; 348/E07.003

(57) ABSTRACT

According to one embodiment, a signal processor includes: a signal input module configured to receive an interlaced-to-progressive following field signal of a predetermined video; a first field delay module configured to delay the following field signal by one field to generate a current field signal; a second field delay module configured to delay the current field signal by one field to generate a preceding field signal; a motion detector configured to detect inter-frame motion for each interpolation target pixel based on the following field signal and the preceding field signal, the interpolation target pixel being a missing pixel within scan lines displaying the video; a boundary specifying module configured to specify a boundary between a moving-image area and a still-image area of the video based on the inter-frame motion; an interpolation pixel generator configured to generate an interpolation pixel that interpolates the interpolation target pixel based on the boundary and at least one of the following field signal, the current field signal, and the preceding field signal; and an output signal generator configured to generate an output signal in which the interpolation target pixel is interpolated by the interpolation signal.

### CROSS-REFERENCE TO RELATED APPLICATIONS

This application is based upon and claims the benefit of priority from Japanese Patent Application No. 2008-273064, filed Oct. 23, 2008, the entire contents of which are incorporated herein by reference.

### BACKGROUND

1. Field

One embodiment of the invention relates to a signal processor and a signal processing method for processing an interlaced video signal.

2. Description of the Related Art

Regarding Television (TV) broadcasting, it has been known to divide a video frame into two video fields with a progressive-to-interlaced scanning in NTSC (National Television Standards Committee) standard, and to transmit the divided video fields. Each video is displayed on a display of a receiver with a number of scan lines which is half of the number of scan lines used to capture the video. Therefore, the division of the frame results in degradation of image quality, and particularly results in degradation of image quality of a still-image.

Recently, digital televisions are widespread. In digital TV broadcasting, a receiver can digitally process video signals easily because the video signals are digitally transmitted to the receiver. Hence, it becomes possible to generate interpolation lines and/or interpolation frames that interpolate interlaced scanning video signals, using digital processing such as interlaced-to-progressive scanning conversion. In the following, pixels in the interpolation lines and/or interpolation frames are referred to as interpolation pixels.

Japanese Patent Application Publication (KOKAI) No. 2008-160773 (hereinafter, referred to as Patent Document 1), for example, discloses a conventional technology related to interlaced-to-progressive scanning conversion. In the conventional technology, an interlaced-to-progressive scanning converter that generates an interpolation pixel by: generating a current field signal by delaying an input interlaced scan video signal (hereinafter referred to as following field signal) by one field; generating a preceding field signal by delaying the current field signal by one field; generating a moving-image interpolation pixel and a still-image interpolation pixel using the aforementioned field signals; and mixing the moving-image interpolation pixel and the still-image interpolation pixel with a predetermined ratio.

In general, in such interlaced-to-progressive scanning conversion, an inter-frame motion vector of frames adjacent to each other in time is calculated for each small region including a plurality of pixels to be interpolated (hereinafter, referred to as interpolation target pixel) based on at least two of the following field signal, the current field signal, and the preceding field signal. Then, the moving-image interpolation pixel is generated based on the motion vector. Further, in such interlaced-to-progressive scanning conversion, inter-frame motion is detected for each interpolation target pixel using area filtering based on the following field signal and the preceding field signal, and mixing ratio of the moving-image interpolation pixels and the still-image interpolation pixels are changed based on the detected inter-frame motion.

Recently, with widespread of digital TV broadcasting, it is becoming popular to display a side panel that displays a still-image of desired information, in addition to displaying normal TV program. However, when the interlaced-to-progressive converter of Patent Document 1 detects the motion vector of the small region containing a boundary between a moving-image region displaying the a TV program and a still-image region displaying the additional information, image degradation such as flicker becomes apparent in the output video near the boundary. This is due to the fact that an interpolation target pixel belonging to the moving-image region and an interpolation target pixel belonging to the still-image region are both interpolated by the same motion vector.

Furthermore, as a result of the area filtering, the interlaced-to-progressive converter of Patent Document 1 determines the inter-frame motion of the interpolation target pixel belonging to the moving-image region more towards still-image, because the inter-frame motion is determined based also on the periphery pixels belonging to the still-image region. Similarly, the interlaced-to-progressive converter of Patent Document 1 determines inter-frame motion of the interpolation target pixel belonging to the still-image region more towards moving-image, because the inter-frame motion is determined based also on the periphery pixels belonging to the moving-image region.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram of a signal processor according to a first embodiment of the invention;

FIG. 2 is an exemplary schematic diagram of a video including a side panel in the embodiment;

FIG. 3A is an exemplary schematic diagram of a video corresponding to a preceding field signal for an inter-frame motion detection in the embodiment;

FIG. 3B is an exemplary schematic diagram of the video corresponding to a following field signal for the inter-frame motion detection in the embodiment;

FIG. 4A is an exemplary schematic diagram of a video corresponding to a preceding field signal for a motion vector detection in the embodiment;

FIG. 4B is an exemplary schematic diagram of the video corresponding to a current field signal in the motion vector detection in the embodiment;

FIG. 4C is an exemplary schematic diagram of the video corresponding to a following field signal in the motion vector detection in the embodiment;

FIG. 5 is an exemplary flowchart of horizontal boundary specifying processing in the embodiment;

FIG. 6 is an exemplary flowchart of motion vector correction based on a horizontal boundary in the embodiment;

FIG. 7 is an exemplary diagram of a video including a side panel according to a second embodiment;

FIG. 8 is an exemplary block diagram of a signal processor in the embodiment;

FIG. 9 is an exemplary flowchart of vertical boundary specifying processing in the embodiment;

FIG. 10 is an exemplary flowchart of motion vector correction based on a vertical boundary in the embodiment;

FIG. 11 is an exemplary schematic diagram of a video including a moving-image region and a still-image region surrounding the moving-image region in all directions in the embodiment;

FIG. 12 is an exemplary schematic diagram of a video including two moving-image regions and a still image region surrounding each of the moving-image regions in all directions in the embodiment;

FIG. 13 is an exemplary block diagram of a signal processor according to a third embodiment;

FIG. 14A is an exemplary schematic diagram of a pixel corresponding to a preceding field signal and an interpolation target pixel, for horizontal edge specifying processing in the embodiment;

FIG. 14B is an exemplary schematic diagram of a pixel corresponding to a following field signal and an Interpolation target pixel, for horizontal edge specifying processing in the embodiment;

FIG. 15 is an exemplary flowchart of the horizontal edge specifying processing in the embodiment;

FIG. 16 is an exemplary schematic diagram for explaining vertical edge specifying processing in the embodiment;

FIG. 17 is an exemplary block diagram of a signal processor according to a fourth embodiment;

FIG. 18 is an exemplary flowchart of motion detection signal correction in the embodiment; and

FIG. 19 is an exemplary block diagram of a signal processor according to a fifth embodiment.

### DETAILED DESCRIPTION

Various embodiments according to the invention will be described hereinafter with reference to the accompanying drawings. In general, according to one embodiment of the invention, a signal processor includes: a signal input module configured to receive an interlaced-to-progressive following field signal of a predetermined video; a first field delay module configured to delay the following field signal by one field to generate a current field signal; a second field delay module configured to delay the current field signal by one field to generate a preceding field signal; a motion detector configured to detect inter-frame motion for each interpolation target pixel based on the following field signal and the preceding field signal, the interpolation target pixel being a missing pixel within scan lines displaying the video; a boundary specifying module configured to specify a boundary between a moving-image area and a still-image area of the video based on the inter-frame motion; an interpolation pixel generator configured to generate an interpolation pixel that interpolates the interpolation target pixel based on the boundary and at least one of the following field signal, the current field signal, and the preceding field signal; and an output signal generator configured to generate an output signal in which the interpolation target pixel is interpolated by the interpolation signal.

Furthermore, according to another embodiment, a signal processing method performed by a signal processor having a signal input module, a first field delay module, a second field delay module, a motion detector, a boundary specifying module, an interpolation pixel generator, and an output signal generator, the signal processing method includes: the signal input module receiving an interlaced-to-progressive following field signal of a predetermined video; the first field delay module delaying the following field signal by one field to generate a current field signal; the second field delay module delaying the current field signal by one field to generate a preceding field signal; the motion detector detecting inter-frame motion for each interpolation target pixel based on the following field signal and the preceding field signal, the interpolation target pixel being a missing pixel within scan lines displaying the video; the boundary specifying module specifying a boundary between a moving-image area and a still-image area of the video based on the inter-frame motion; the interpolation pixel generator generating an interpolation pixel that interpolates the interpolation target pixel based on the boundary and at least one of the following field signal, the current field signal, and the preceding field signal; and the output signal generator generating an output signal in which the interpolation target pixel is interpolated by the interpolation signal.

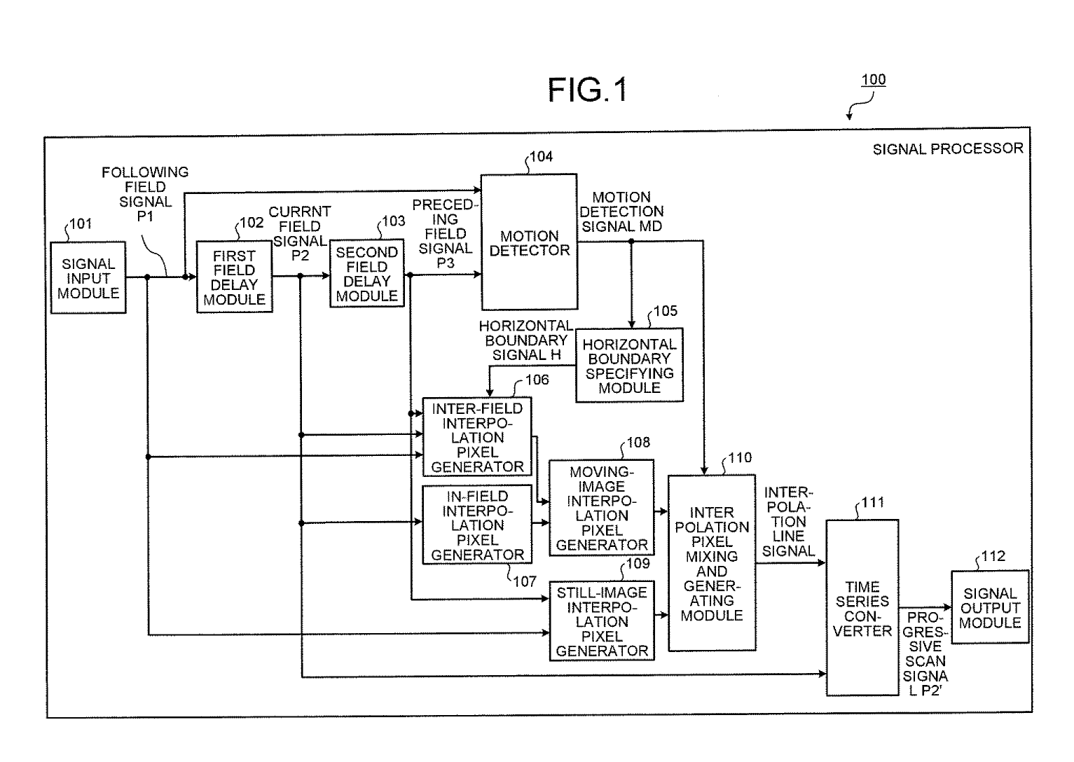

A first embodiment of the invention will be described based on FIG. 1 to FIG. 6. The present embodiment explains an example in which a signal processor is applied as an interlaced-to-progressive scanning converter. FIG. 1 is a block diagram of a signal processor of the first embodiment.

A signal processor 100 includes a signal input module 101, a first field delay module 102, a second field delay module 103, a motion detector 104, a horizontal boundary specifying module 105, an inter-field interpolation pixel generator 106, an in-field interpolation pixel generator 107, a moving-image interpolation pixel generator 108, a still-image interpolation pixel generator 109, an interpolation pixel mixing and generating module 110, a time series converter 111, and a signal output module 112.

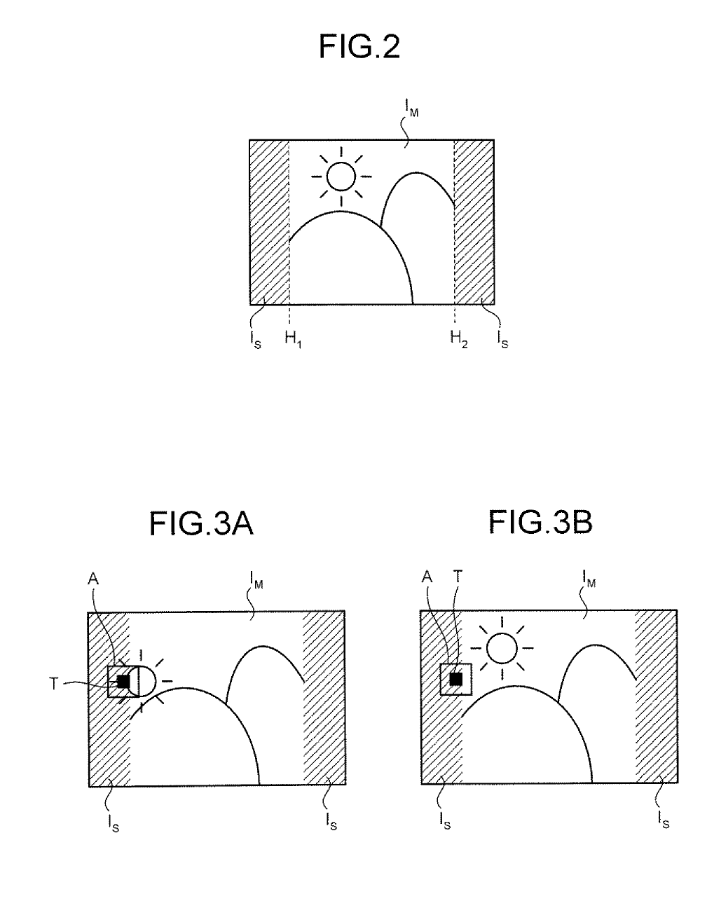

The signal input module 101 receives an interlaced scanning video signal provided by a broadcast station through digital broadcasting, and outputs it as a following field signal P1 to the first field delay module 102, the motion detector 104, the inter-field interpolation pixel generator 106, and the still-image interpolation pixel generator 109. The interlaced scanning video signal is in NTSC (National Television System Committee) format. That is to say, the video generated at the broadcast station is configured by the interlaced scanning video signal corresponding to one of an odd field and an even field of one frame. The odd field has odd scan lines of the frame, and the even field has even scan lines of the frame. In the following, a video generated at the broadcast station includes a moving-image region I_{M} displaying an ordinary television program and a still-image region I_{S} on horizontal right and left of the moving-image region I_{M} as a side panel, as for example illustrated in FIG. 2. The moving-image region I_{M} and the still-image region I_{S} are separated by a horizontal boundary H1 or H2.

The first field delay module 102 delays the following field signal P1 output by the signal input module 101 by one field to generate a current field signal P2, and outputs it to the second field delay module 103, the inter-field interpolation pixel generator 106, the in-field interpolation pixel generator 107, and the time series converter 111.

The second field delay module 103 delays the current field signal P2 output by the first field delay module 102 by one field to generate a preceding field signal P3, and outputs it to the motion detector 104, the inter-field interpolation pixel generator 106, and the still-image interpolation pixel generator 109.

In the present embodiment, a pixel interpolation is performed by the signal processor 100 on the current field signal P2. That is to say, the signal processor 100 generates an interpolation pixel interpolating a pixel (hereinafter, referred to as an interpolation target pixel) of which the current field signal P2 is missing such as of the odd scan lines or even scan lines, based on at least one of the following field signal P1, the current field signal P2, and the preceding field signal P3.

The motion detector 104 detects inter-frame motion of frames adjacent in time for each interpolation target pixel, and outputs it to the horizontal boundary specifying module 105 and the interpolation pixel mixing and generating module 110 as a motion detection signal MD. In particular, the motion detector 104 calculates a difference between the following field signal P1 output by the signal input module 101 and the preceding field signal P3 output by the second field delay module P3, as the motion detection signal MD. The scan lines corresponding to the following field signal P1 and the preceding field signal PS corresponds to the scan lines of which the current field signal P2 is missing. Hence, the motion detection signal MD calculated based on the following field signal P1 and the preceding field signal P3 is associated with the interpolation target pixel of the current field signal P2.

It is difficult to accurately perform the motion detection based on one pixel corresponding to the following field signal P1 and one pixel corresponding to the preceding field signal P3 having the same spatial position as that of the pixel corresponding to the following field signal P1 because of signal degradation due to noise and the like. Therefore, as in FIG. 3A illustrating a video corresponding to the preceding field signal P3 and in FIG. 3B illustrating a video corresponding to the following field signal P1, the inter-frame motion of the interpolation target pixel T is detected by area filtering taking into account motion of periphery pixels contained in a periphery region A having the interpolation target pixel T at the center. Such motion detection may be performed, for example, by calculating the inter-frame difference value of the interpolation target pixel T, calculating inter-frame difference value of each periphery pixel, and averaging the calculated difference values, to detect the motion detection signal MD of the interpolation target pixel T.

As described hereinafter, the horizontal boundary specifying module 105 detects horizontal boundary coordinates between the moving-image region and the still-image region in the input video, determines horizontal boundaries H1 and H2 based on the detected horizontal boundary coordinates, and outputs the determined horizontal boundaries H1 and H2 to the inter-field interpolation pixel generator 106 as a horizontal boundary signal H.

The inter-field interpolation pixel generator 106 generates an inter-field interpolation pixel based on at least two of the following field signal P1, the current field signal P2, and the preceding field signal P3. Then, the inter-field interpolation pixel generator 106 outputs the generated field interpolation pixel to the moving-image interpolation pixel generator 108. In particular, the inter-field interpolation pixel generator 106 calculates an inter-frame motion vector described later based on two field signals differing from each other in frames among the following field signal P1, the current field signal P2, and the preceding field signal P3. Then, the inter-field interpolation pixel generator 106 corrects the calculated inter-frame motion vector by motion vector correction described later, and generates the inter-field interpolation pixel based on the corrected motion vector.

The motion vector is a vector that indicates magnitude and direction of motion of video in two frames adjacent to each other in time. For example, block matching is known as a method of detecting such motion vector. The block matching divides, for example, a first frame of two frames adjacent to each other in time into a plurality of small regions, specifies a small region in a second frame of the two frames which is closest to the small region in the first frame, and obtains the motion vector from the coordinates of the small regions in the first and the second frames.

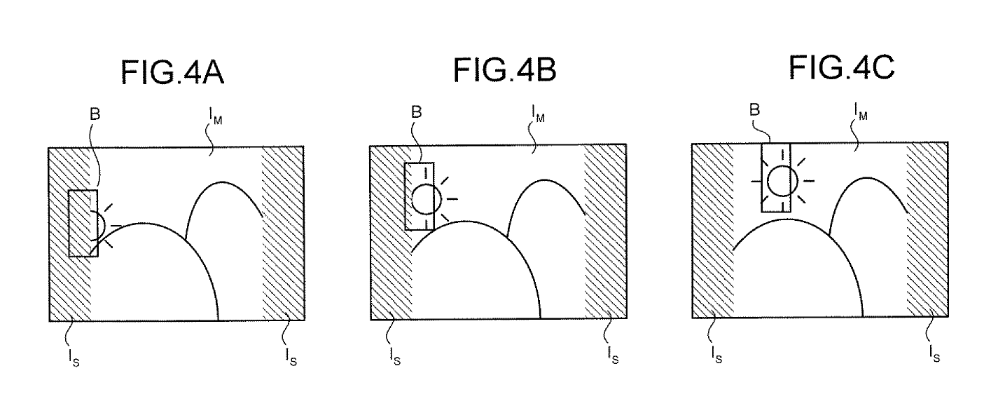

For example, assume that such block matching specifies a small region B in the video of FIG. 4A and a small region B in the video of FIG. 4C as being the most similar to each other. Then, the block matching calculates the motion vector of the small region B based on the magnitude and the direction of the motion of the small region B between the frames. Here, FIG. 4A corresponds to the preceding field signal P3, and FIG. 4C corresponds to the following field signal P1 corresponding to a frame differing in time from the frame corresponding to the preceding field signal P3. As illustrated in FIGS. 4A and 4C, position coordinates of the small region B greatly differ between the video corresponding to the following fields signal P1 and the video corresponding to the preceding field signal P3. Hence, the motion vector calculated from the coordinates of the aforementioned small regions is determined as moving-image. However, when an interpolation pixel in the small region B of the video of FIG. 4B corresponding to the current field signal P2 is generated based on such motion vector, an interpolation pixel in the still-image region of the small region B in FIG. 4B is to be generated based on such motion vector determined as the moving-image, regardless of the fact that the small region B contains the still-image region.

Hence, the inter-field interpolation pixel generator 106 performs the motion vector correction described later to determine whether the interpolation target pixel belongs to the moving-image region or the still-image region. As a result, the inter-field interpolation pixel generator 106 corrects the motion vector more towards the moving-image when the interpolation target pixel is determined to belong to the moving-image region, and corrects the motion vector more towards the still-image when the interpolation target pixel is determined to belongs to the still-image region. Here, the correction towards the moving-image means at least to increase the magnitude of the motion vector with respect to the magnitude thereof before the correction. Similarly, the correction towards the still-image means at least to decrease the magnitude of the motion vector with respect to the magnitude thereof before the correction.

The in-field interpolation pixel generator 107 generates an in-field interpolation pixel based on the current field signal P2, and outputs it to the moving-image interpolation pixel generator 108. In particular, supposing that the current field signal P2 corresponds to the even field of one frame, the inter-field interpolation pixel generator 106 generates the in-field interpolation pixel by using even scan lines of the even field as odd scan lines.

The moving-image interpolation pixel generator 108 mixes the inter-field interpolation pixel and the in-field interpolation pixel with a predetermine mixing ratio to generates the moving-image interpolation pixel, and outputs it to the interpolation pixel mixing and generating module 110.

The still-image interpolation pixel generator 109 generates a still-image interpolation pixel based on the following field signal P1 or the preceding field signal P3, and outputs it to the interpolation pixel mixing and generating module 110. More particularly, the still-image interpolation pixel generator 109 uses a field signal corresponding to a frame that differs from a frame corresponding to the current field signal P2.

The interpolation pixel mixing and generating module 110 mixes the moving-image interpolation pixel generated by the moving-image interpolation pixel generator 108 and the still-image interpolation pixel generated by the still-image interpolation pixel generator 109 to generate an interpolation pixel based on the following equation (1)

(Interpolation pixel signal)=MD×(moving-image interpolation pixel)+(1−MD)×(still-image interpolation pixel) (1)

where MD represents motion detection signal and satisfies the following condition: 0≦MD≦1. MD=0 represents the smallest motion of the interpolation target pixel (that is, the determination is towards the still-image determination), and MD=1 represents the largest motion of the interpolation target pixel (that is, the determination is towards the moving-image determination). The interpolation pixel mixing and generating module 110 outputs the interpolation pixel to the time series converter 111 by each interpolation line. That is to say, the interpolation pixel mixing and generating module 110 increases the ratio of the still-image interpolation pixel with respect to the moving-image interpolation pixel as the determination of the inter-frame motion shifts towards the still-image determination, while increasing the ratio of the moving-image interpolation pixel with respect to the still-image interpolation pixel as the determination of the inter-frame motion shifts towards the moving-image determination. Thereafter, the interpolation pixel mixing and generating module 110 mixes the resultant still-image interpolation pixel and the moving-image interpolation pixel.

The time series converter 111 generates a progressive scan signal P2′ based on the interpolation line output by the interpolation pixel mixing and generating module 110 and the current field signal P2, and outputs it to the signal output module 112. The signal output module 112 outputs the progressive scan signal P2′ to a display and the like not illustrated connected to the signal processor 100. As a result, the display displays a video based on the progressive scan signal P2′.

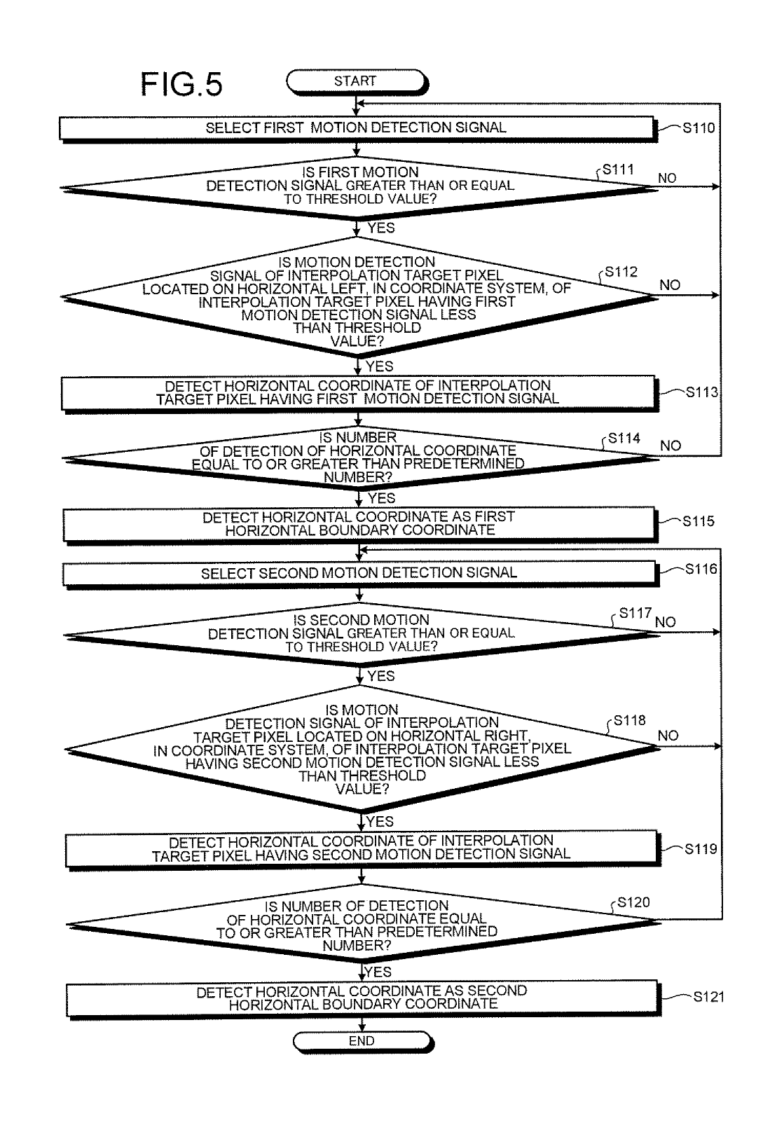

Next, horizontal boundary coordinate detection of the horizontal boundary specifying module 105 is explained with reference to FIG. 5. FIG. 5 is a flowchart of the horizontal boundary coordinate detection.

The horizontal boundary specifying module 105 selects, among the motion detection signals MD output from the motion detector 104, a first motion detection signal MD_{T1} not yet selected as a first motion detection signal (S110). Next, the horizontal boundary specifying module 105 determines whether the selected first motion detection signal MD_{T1} is greater than or equal to a predetermined threshold value (S111). Here, the predetermined threshold value is a reference value for determining whether the motion detection signal is determined as the moving-image or as the still-image. In particular, the motion detection signal is determined as to correspond to a moving-image when the motion detection signal is greater than or equal to the predetermined threshold value. In other words, an interpolation target pixel corresponding to the motion detection signal is determined as to belong to the moving-image region. On the other hand, the motion detection signal is determined as to correspond to a still-image when the motion detection signal is less than the predetermined threshold value. In other words, an interpolation target pixel corresponding to the motion detection signal is determined as to belong to the still-image region.

When, as a result of S111, the horizontal boundary specifying module 105 determines that the first motion detection signal MD_{T1} is not greater than or equal to the predetermined threshold value (No at S111), the horizontal boundary specifying module 105 repeats the processing beginning with S110. On the other hand, when it is determined that the first motion detection signal MD_{T1} is greater than or equal to the threshold value (Yes at S111), the horizontal boundary specifying module 105 determines whether a motion detection signal corresponding to an interpolation target pixel located on the horizontal left, in the coordinate system, of the interpolation target pixel having the first motion detection signal is less than the threshold value (S112). Then, when it is determined that the motion detection signal corresponding to the interpolation target pixel located on the left is not less than the threshold value (No at S112), the horizontal boundary specifying module 105 repeats processing beginning with S110.

On the other hand, as a result of S112, when it is determined that the motion detection signal of the interpolation target pixel located on the horizontal left is less than the threshold value (Yes at S112), the horizontal boundary specifying module 105 detects horizontal coordinates of the interpolation target pixel having the first motion detection signal MD_{T1} (S113).

Next, the horizontal boundary specifying module 105 determines whether the number of detection of the horizontal coordinates is greater than or equal to a predetermined number (S114). That is to say, the horizontal boundary specifying module 105 determines whether identical horizontal coordinates are detected at S113 for more than the predetermined number.

As a result of S114, when the number of detection of the horizontal coordinates is not greater than or equal to the predetermined number (No at S114), the horizontal boundary specifying module 105 repeats the processing beginning with S110. On the other hand, when the number of detection of the horizontal coordinates is greater than or equal to the predetermined number (Yes at S114), the horizontal boundary specifying module 105 detects the horizontal coordinates as the first horizontal boundary coordinates (S115).

Next, the horizontal boundary specifying module 105 selects, among the motion detection signals MD output from the motion detector 104, a second motion detection signal MD_{T2} not yet selected as a second motion detection signal (S116). Then, the horizontal boundary specifying module 105 determines whether the selected second motion detection signal MD_{T2} is greater than or equal to the predetermined threshold value (S117). As a result, when it is determined that the second motion detection signal MD_{T2} is not greater than or equal to the predetermined threshold value (No at S117), the horizontal boundary specifying module 105 repeats the processing beginning with S116. On the other hand, when it is determined that the second motion detection signal MD_{T2} is greater than or equal to the threshold value (Yes at S117), the horizontal boundary specifying module 105 determines whether a motion detection signal corresponding to an interpolation target pixel located on the horizontal right, in the coordinate system, of the interpolation target pixel having the second motion detection signal is less than the threshold value (S118).

As a result, when it is determined that the motion detection signal corresponding to the interpolation target pixel located on the left is not less than the threshold value (No at S118), the horizontal boundary specifying module 105 repeats the processing beginning with S116. On the other hand, when it is determined that the motion detection signal of the interpolation target pixel located on the horizontal left is less than the threshold value (Yes at S118), the horizontal boundary specifying module 105 detects horizontal coordinates of the interpolation target pixel having the second motion detection signal MD_{T2} (S119).

Next, the horizontal boundary specifying module 105 determines whether the number of detection of the horizontal coordinates is greater than or equal to a predetermined number (S120). That is to say, the horizontal boundary specifying module 105 determines whether identical horizontal coordinates are detected at S119 for more than the predetermined number.

As a result of S120, when the number of detection of the horizontal coordinates is not greater than or equal to the predetermined number (No at S120), the horizontal boundary specifying module 105 repeats the processing beginning with S116. On the other hand, when the number of detection of the horizontal coordinates is greater than or equal to the predetermined number (Yes at S120), the horizontal boundary specifying module 105 detects the horizontal coordinates as second horizontal boundary coordinates (S105).

As described above, the horizontal boundary specifying module 105 detects the horizontal boundary coordinates of one of the horizontally adjacent interpolation target pixels the inter-frame motion of which is determined as the moving-image, as a result of the horizontal boundary coordinate detection. Accordingly, horizontal boundaries H1 and H2 corresponding to the two horizontal boundary coordinates can be specified, and it becomes capable to identify the moving-image region and the still-image region in the input video.

Besides, the horizontal boundary specifying module 105 may specify the horizontal boundary when the inter-frame motion is fixed. That is to say, the horizontal boundary specifying module 105 may specify the horizontal boundaries H1 and H2 corresponding to the horizontal boundary coordinates when the same horizontal coordinates are detected for certain time period. Accordingly, the horizontal coordinates can be specified more accurately.

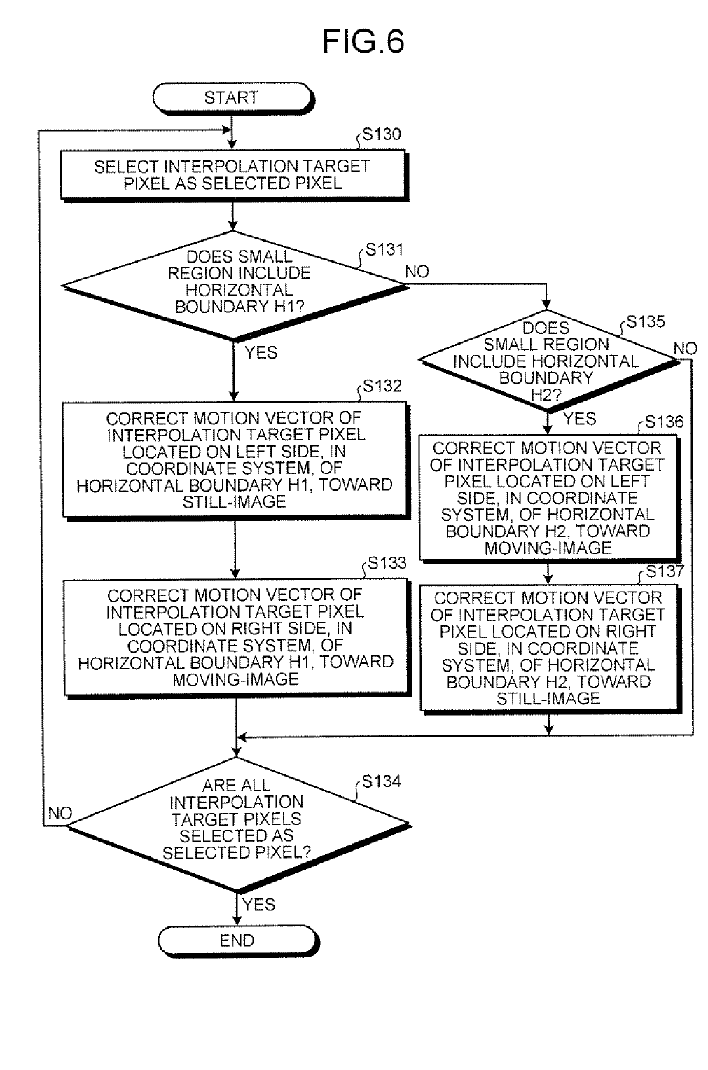

Next, a motion vector correction by the inter-field interpolation pixel generator 106 is explained with reference to FIG. 6. FIG. 6 is a flowchart of the motion vector correction. As described above, the inter-field interpolation pixel generator 106 divides a video formed of one of the following field signal P1 and the preceding field signal P3 into a plurality of small regions, and specifies a small region in a video formed of other one of the following field signal P1 and the preceding field signal P3, the small region of which is similar to a small region of the video formed of the one of the following field signal P1 and the preceding field signal P3. Then, the inter-field interpolation pixel generator 106 calculates the motion vector based on the coordinates of the similar small regions.

When the motion vectors of all interpolation target pixels are calculated, the inter-field interpolation pixel generator 106 selects as a selected pixel an interpolation target pixel not yet selected as the selected pixel (S130). Next, the inter-field interpolation pixel generator 106 determines whether the horizontal boundary H1 is included in the small region used when the motion vector of the selected pixel is calculated (S131). Then, when it is determined that the horizontal boundary H1 is not included in the small region, the inter-field interpolation pixel generator 106 performs S135 described in the following (No at S131). On the other hand, when it is determined that the horizontal boundary H1 is included in the small region, the inter-field interpolation pixel generator 106 corrects the motion vector of the interpolation target pixel located on the left side, in the coordinate system, of the horizontal boundary H1 more towards the still-image (S132). Further, the inter-field interpolation pixel generator 106 corrects the motion vector of the interpolation target pixel located on the right side, in the coordinate system, of the horizontal boundary H1 more towards the moving-image (S133). Then, the inter-field interpolation pixel generator 106 determines whether all of the interpolation target pixels are selected as the selected pixel (S134). When all of the interpolation target pixels are not yet selected as the selected pixel (No at S134), the inter-field interpolation pixel generator 106 repeats the processing beginning with S130. On the other hand, when all of the interpolation target pixels are selected as the selected pixel (Yes at S134), the inter-field interpolation pixel generator 106 ends the motion vector correction.

On the other hand, as a result of S131, when it is determined that the horizontal boundary H1 is not included in the small region (No at S131), the inter-field interpolation pixel generator 106 determines whether the horizontal boundary H2 is included in the small region (S135). Then, when it is determined that the horizontal boundary H2 is not included in the small region (No at S135), the inter-field interpolation pixel generator 106 performs S134. On the other hand, when it is determined that the horizontal boundary H2 is included in the small region (Yes at S135), the inter-field interpolation pixel generator 106 corrects the motion vector of the interpolation target pixel located on the left side, in the coordinate system, of the horizontal boundary H2 more towards the moving-image (S136). Further, the inter-field interpolation pixel generator 106 corrects the motion vector of the interpolation target pixel located on the right side, in the coordinate system, of the horizontal boundary H2 more towards the still-image (S137).

As described above, according to the first embodiment, the interpolation pixels are generated using the corrected motion vector of the interpolation target pixel near the boundary between the moving-image region and the still-image region. In particular, the horizontal boundary specifying module specifies the moving-image region and the still-image region, the inter-field interpolation pixel generator corrects the motion vector of the interpolation target pixel near the boundary more towards the moving-image when the interpolation target pixel is specified as to belong to the moving-image region, and corrects the motion vector of the interpolation target pixel near the boundary more towards the still-image when the interpolation target pixel is specified as to belong to the still-image region. Then, the interpolation pixels are generated near the boundary based on the corrected motion vector. Consequently, it becomes possible to suppress image quality degradation such as flicker near the boundary between the moving-image region and the still-image region of the output video.

In the first embodiment, the horizontal boundaries is specified by detecting the horizontal coordinates of one of the interpolation target pixels horizontally adjacent to each other and the inter-frame motion of which is determined as the moving-image. However, the horizontal boundaries may be specified by the interpolation target pixels in a region bounded between first coordinates at a predetermined horizontal length away from the detected horizontal coordinates and by second coordinates at the predetermined horizontal length away from the detected horizontal coordinates.

Further, in the first embodiment, the horizontal boundary H is specified prior to specifying the horizontal boundary H2. However, the horizontal boundary H2 may be specified prior to specifying the horizontal boundary H1. Furthermore, the determination of the horizontal boundaries H1 and H2 may be performed for each motion detection signal.

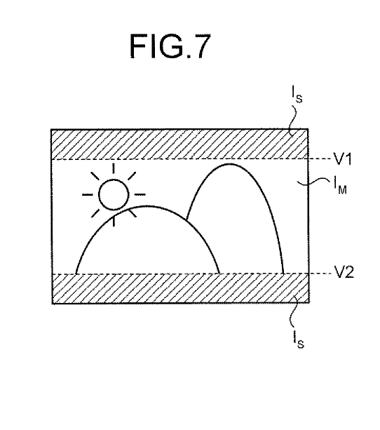

Next, a second embodiment of the present invention is explained with reference to FIGS. 7 to 12. A signal processor and a signal processing method of the present embodiment differs from the signal processor and the signal processing method of the first embodiment in terms of the internal processing of the inter-field interpolation pixel generator. Thus, the same letters and numbers are assigned for parts and elements that are similar to that of the aforementioned first embodiment, and the explanations thereof are omitted. In the present embodiment, it is explained processing of video signals of a movie and the like having a moving-image region and a still-image region above and below the moving-image region, as illustrated in FIG. 7. The still-image region corresponds to, for example, side panels displaying subtitles of the movie and the like.

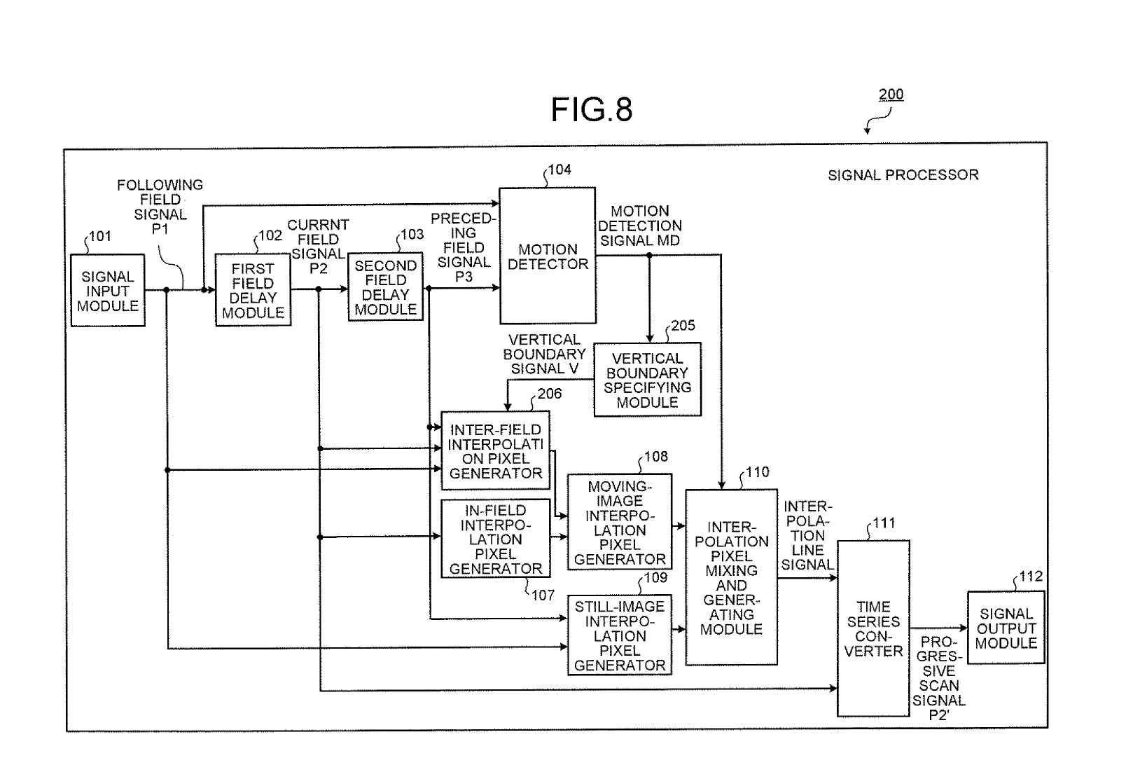

FIG. 8 is a block diagram of a signal processor 200 of the present embodiment. The signal processor 200 has a vertical boundary specifying module 205 and an inter-field interpolation pixel generator 206, instead of the horizontal boundary specifying module 105 and the inter-field interpolation pixel generator 106 of the signal processor 100 of the first embodiment.

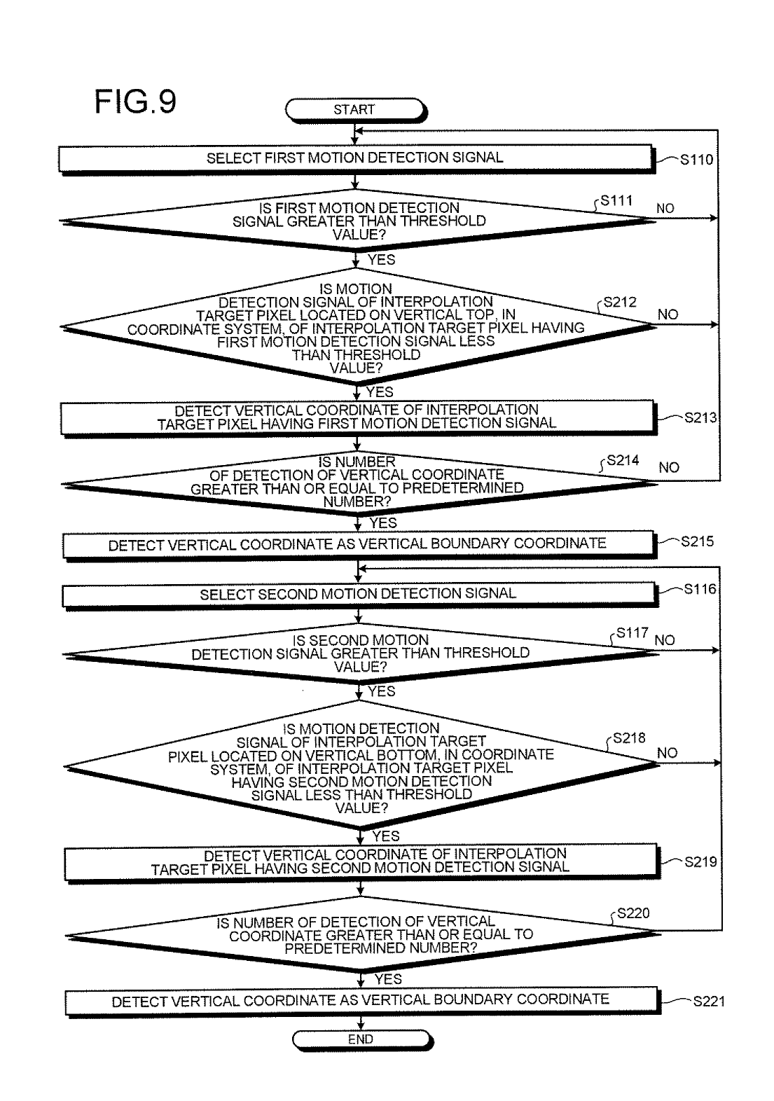

In the following, vertical boundary coordinate detection of the vertical boundary specifying module 205 is explained. FIG. 9 is a flowchart of the vertical boundary coordinate detection. As a result of S111, when the vertical boundary specifying module 205 determines that the first motion detection signal MD_{T1} is greater than or equal to the threshold value (Yes at Step S111), the vertical boundary specifying module 205 determines whether a motion detection signal of an interpolation target pixel located on the vertical top, in the coordinate system, of the interpolation target pixel having the first motion detection signal MD_{T1} is less than the threshold value (S212). Then, when it is determined that the motion detection signal of the interpolation target pixel located on the vertical top is not less than the threshold value (No at S212), the vertical boundary specifying module 205 repeats the process beginning with S110.

On the other hand, when it is determined that the motion detection signal of the interpolation target pixel located on the vertical top is less than the threshold value (Yes at S212), the vertical boundary specifying module 205 detects vertical coordinates of the interpolation target pixel having the first motion detection signal MD_{T1} (S213).

Next, the vertical boundary specifying module 205 determines whether the number of detection of the detected vertical coordinates is greater than or equal to a predetermined number (S214). In particular, the vertical boundary specifying module 205 determines whether identical vertical coordinates are detected by S213 for more than the predetermined number of times.

As a result of S214, when it is determined that the number of detection of the vertical coordinates is not greater than or equal to the predetermined number (No at S214), the vertical boundary specifying module 205 repeats the process beginning with S110. On the other hand, when it is determined that the number of detection of the vertical coordinates is greater than or equal to the predetermined number (Yes at S214), the vertical boundary specifying module 205 detects the vertical coordinates as first vertical boundary coordinates (S215).

Next, the vertical boundary specifying module 205 performs S116 and S117. Then, when the result of S117 is No, the vertical boundary specifying module 205 repeats the process beginning with S116. On the other hand, when the result of S117 is Yes, then the vertical boundary specifying module 205 determines whether a motion detection signal of an interpolation target pixel located on the vertical bottom, in the coordinate system, of the interpolation target pixel having the second motion detection signal MD_{T2} is less than the threshold value (S218).

As a result, when it is determined that the motion detection signal of the interpolation target pixel located on the vertical bottom is not less than the threshold value (No at S218), the vertical boundary specifying module 205 repeats the process beginning with S116. On the other hand, when it is determined that the motion detection signal of the interpolation target pixel located on the vertical bottom is less than the threshold value (Yes at S218), the vertical boundary specifying module 205 detects vertical coordinates of the interpolation target pixel having the second motion detection signal MD_{T2} (S219).

Then, the vertical boundary specifying module 205 determines whether number of detection of the vertical coordinates is greater than or equal to a predetermined number. More particularly, the vertical boundary specifying module 205 detects whether identical vertical coordinates are detected by S219 for more than the predetermined number of times.

As a result of S220, when it is determined that the number of detection of the vertical coordinates is not greater than or equal to the predetermined number (No at S220), the vertical boundary specifying module 205 repeats the process beginning with S116. On the other hand, when it is determined that the number of detection of the vertical coordinates is greater than or equal to the predetermined number (Yes at S220), the vertical boundary specifying module 205 detects the vertical coordinates as second vertical boundary coordinates (S221).

As described above, the vertical boundary specifying module 205 detects, by the aforementioned vertical boundary coordinate detection, the vertical coordinates of one of the vertically adjacent interpolation target pixels the inter-frame motion of which is determined as the moving-image. Accordingly, vertical boundaries V1 and V2 corresponding to the two vertical boundary coordinates can be specified, and the still-image region and the moving-image region can be recognized. The specified vertical boundaries V1 and V2 are output to the inter-field interpolation pixel generator 206 as a vertical boundary signal V.

The vertical boundary specifying module 205 may specify the vertical boundaries when the inter-frame motion is fixed. That is to say, the vertical boundary specifying module 205 may specify the vertical boundaries V1 and V2 corresponding to the vertical boundary coordinates when the vertical coordinates are detected at the same position for a certain period of time. Consequently, the vertical boundaries can accurately be specified.

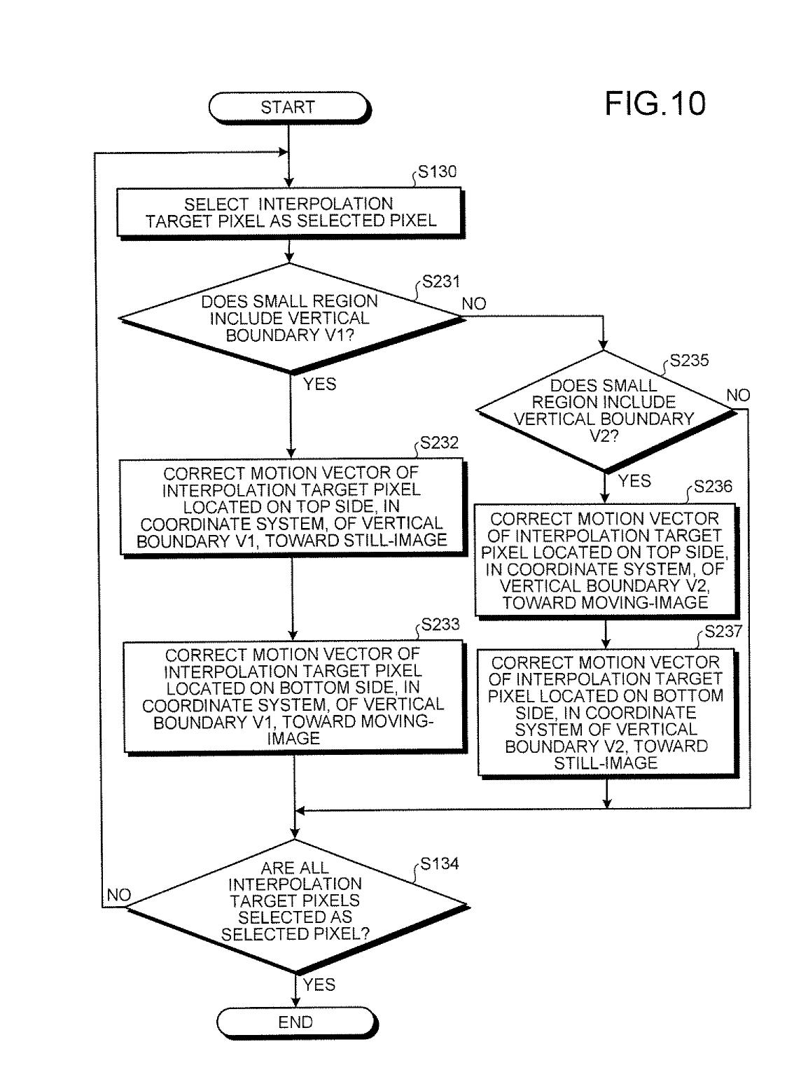

Next, motion vector correction of the inter-field interpolation pixel generator 206 is explained with reference to FIG. 10. FIG. 10 is a flowchart of the motion vector correction based on the vertical boundary signal V.

After S130, the inter-field interpolation pixel generator 206 determines whether the vertical boundary V1 is included in the small region used to calculate the motion vector of the selected pixel (S231). When it is determined that the vertical boundary V1 is included in the small region (Yes at S231), the inter-field interpolation pixel generator 206 corrects the motion vector of the interpolation target pixel located on the top side, in the coordinate system, of the vertical boundary V1 more towards the still-image (S232). Further, the inter-field interpolation pixel generator 206 corrects the motion vector of the interpolation target pixel located on the bottom side, in the coordinate system, of the vertical boundary V1 more towards the moving-image (S233). Then, the inter-field interpolation pixel generator 106 performs S134.

On the other hand, as a result of S231, when it is determined that the vertical boundary V1 is not included in the small region (No at S231), then the inter-field interpolation pixel generator 206 determines whether the vertical boundary V2 is included in the small region (S235). As a result, when it is determined that the vertical boundary V2 is not included in the small region (No at S235), the inter-field interpolation pixel generator 206 performs S134. On the other hand, when it is determined that the vertical boundary V2 is included in the small region, the inter-field interpolation pixel generator 206 corrects the motion vector of the interpolation target pixel located on the top side, in the coordinate system, of the vertical boundary V2 more towards the moving-image (S236). Further, the inter-field interpolation pixel generator 206 corrects the motion vector of the interpolation target pixel located on the bottom side, in the coordinate system, of the vertical boundary V2 more towards the still-image (S237). Then, the inter-field interpolation pixel generator 206 performs S134.

As described above, the signal processor and the signal processing method of the present embodiment generates the interpolation pixels near the boundary between the moving-image region and the still-image region using the corrected motion vector. In particular, the vertical boundary specifying module specifies the moving-image region and the still-image region, the inter-field interpolation pixel generator corrects the motion vector of the interpolation target pixel near the boundary more towards the moving-image when the interpolation target pixel is specified as to belong to the moving-image region, and corrects the motion vector of the interpolation target pixel near the boundary more towards the still-image when the interpolation target pixel is specified as to belong to the still-image region. Then, the signal processor and the signal processing method generate the interpolation pixels near the boundary based on the corrected motion vector. Consequently, it becomes possible to suppress image quality degradation such as flicker near the boundary between the moving-image region and the still-image region of the output video.

As mentioned above, the signal processor and the signal processing method of the present embodiment specify the vertical boundaries by detecting the vertical coordinates of one of the interpolation target pixels vertically adjacent to each other and the inter-frame motion of which is determined as the moving-image determination. However, the vertical boundaries may be specified by the interpolation target pixels contained in a region bounded between first coordinates at a predetermined horizontal length away from the detected horizontal coordinates and by second coordinates at the predetermined horizontal length away from the detected horizontal coordinates.

Further, as described above, the signal processor and the signal processing method of the present embodiment specify the horizontal boundary H1 prior to specifying the horizontal boundary H2. However, the horizontal boundary H2 may be specified prior to specifying the horizontal boundary H1. Furthermore, the determination of the horizontal boundaries H1 and H2 may be performed for each motion detection signal.

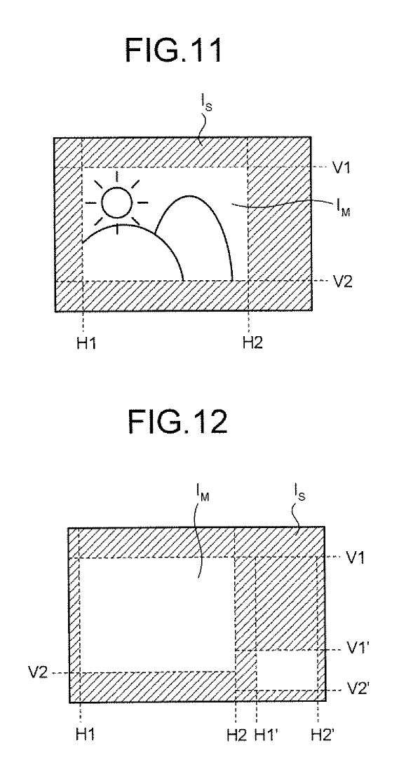

Moreover, according to the second embodiment, it is possible to correct the motion vector of the interpolation target pixel near the boundary for a video, such as illustrated in FIG. 11, having a moving-image region surrounded by a still-image region displaying breaking news of earth quake and the like. In particular, the motion vector of the interpolation target pixel near the boundary can be corrected by combining the vertical boundary specifying module of the second embodiment with the horizontal boundary specifying module of the first embodiment to specify both of the horizontal boundaries and the vertical boundaries.

Furthermore, it is possible to specify the horizontal boundaries and the vertical boundaries repeatedly for an interpolation target pixel other than the interpolation target pixel already specified as the horizontal boundaries and the vertical boundaries. More particularly, the motion vector of the interpolation target pixel near the boundaries can be appropriately corrected for the video having two moving-image regions surrounded by still-image region, as in FIG. 12. Further in details, the horizontal boundary specifying module specifies the horizontal boundaries H1 and H2, the vertical boundary specifying module specifies the vertical boundaries V1 and V2, and the horizontal boundary coordinate detection and the vertical boundary coordinate detection are repeatedly performed for the still-image region. Consequently, the horizontal boundaries H1′ and H2′ and the vertical boundaries V1′ and V2′ can be specified, and the motion vector can suitably be corrected near the boundary between the moving-image region and the still-image region.

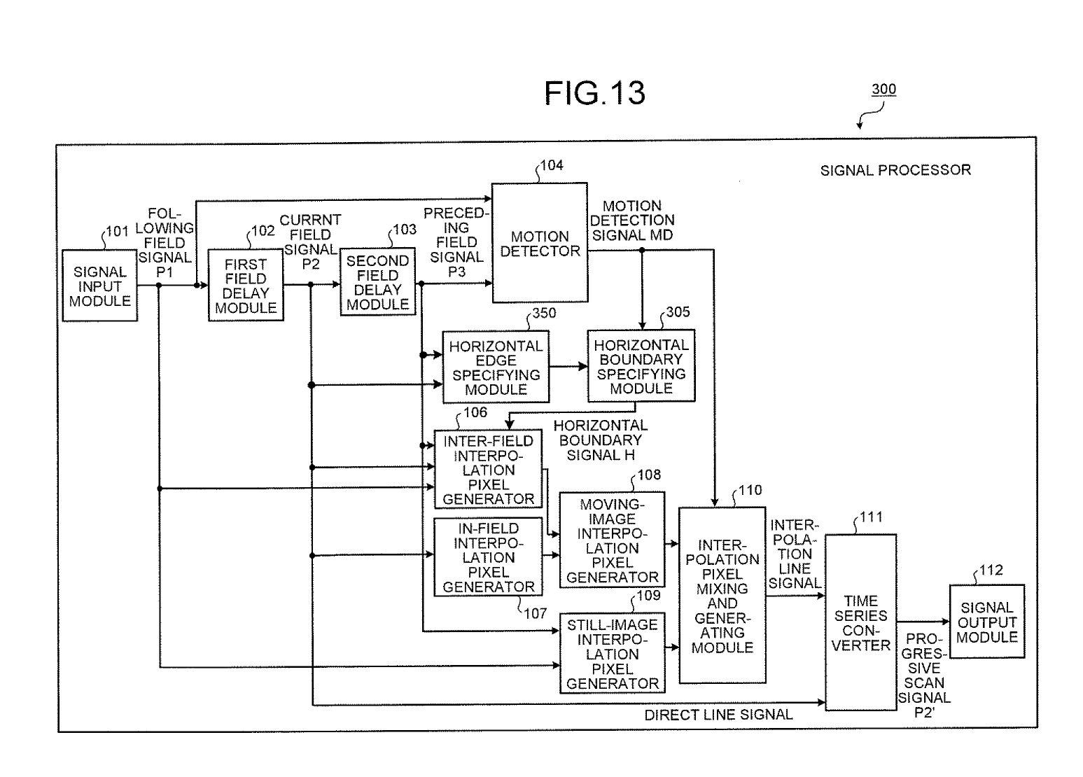

Next, a third embodiment of the present invention is explained with reference to FIGS. 13 to 16. A signal processor and a signal processing method of the present embodiment differs from the signal processor and the signal processing method of the first embodiment in terms of the internal processing of the horizontal boundary specifying module and in that the horizontal edge specifying module is added. Thus, the same letters and numbers are assigned for parts and elements that are similar to that of the aforementioned first embodiment, and the explanations thereof are omitted. In the present embodiment, a video as in FIG. 2 having added the side panel on both sides of the moving-image region is input to the signal processor as an input video.

FIG. 13 is a block diagram of a signal processor 300 of the present embodiment. The signal processor 300 has a horizontal edge specifying module 350 that detects a horizontal edge of the moving-image region and the still-image region in the input video based on the current field signal P2 and the preceding field signal P3. A horizontal boundary specifying module 305 specifies a boundary between the moving-image region and the still-image region in the input video based on the motion detection signal MD and the horizontal edge, and outputs the horizontal boundary signal H to the inter-field interpolation pixel generator 106.

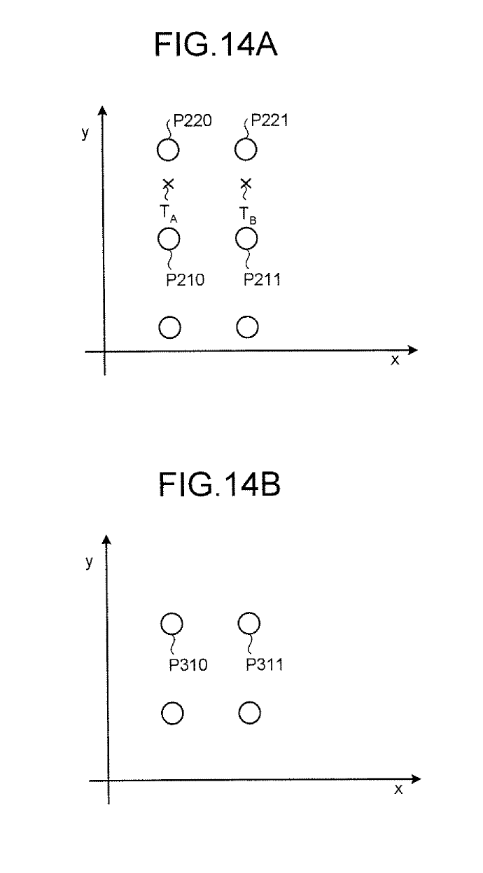

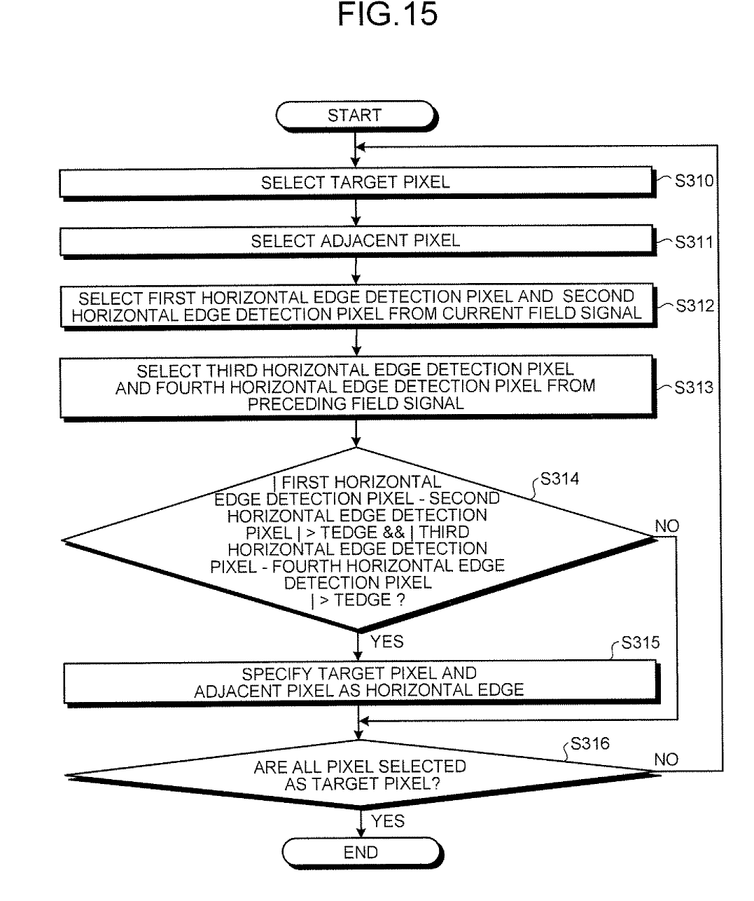

The horizontal edge specifying module 350 is explained in details with reference to FIGS. 14 and 15. FIG. 14A illustrates an interpolation target pixel T_{A}, pixels P210 and P220 spatially adjacent to the interpolation target pixel T_{A} in vertical upward and downward directions, an interpolation target pixel T_{B} spatially adjacent to the interpolation target pixel T_{A} in horizontal right direction, and pixels P211 and P221 spatially adjacent to the interpolation target pixel T_{B} in vertical upward and downward directions. FIG. 14B illustrates pixels P310 and P311 located on spatially the same position as that of the interpolation target pixels T_{A} and T_{B}. The pixels P210, P211, P220, and P221 are included in the current field signal P2, and the pixels P310 and P311 are included in the preceding field signal P3.

FIG. 15 is a flowchart of the horizontal edge specifying processing by the horizontal edge specifying module 350. The horizontal edge specifying module 350 selects an interpolation target pixel not yet selected as a target pixel, such as the interpolation target pixel T_{A} in FIG. 14A, as the target pixel (S310). Next, the horizontal edge specifying module 350 selects an interpolation target pixel located on the right of the target pixel, such as the interpolation target pixel T_{B} in FIG. 14A, as an adjacent pixel (S311).

Next, the horizontal edge specifying module 350 selects, from the current field signal P2, a first horizontal edge detection pixel located spatially above the target pixel, such as the pixel P220 in FIG. 14A (S312). Further, the horizontal edge specifying module 350 selects, from the current field signal P2, a second horizontal edge detection pixel located spatially above the adjacent pixel, such as the pixel P221 in FIG. 14A (S312).

Further, the horizontal edge specifying module 350 selects, from the preceding field signal P3, a third horizontal edge detection pixel located at the same spatial position as that of the target pixel, such as the pixel P310 in FIG. 14B (S313). Further, the horizontal edge specifying module 350 selects, from the preceding field signal P3, a fourth horizontal edge detection pixel located at the same spatial position as that of the adjacent pixel, such as the pixel P311 in FIG. 15B (S313).

Then, the horizontal edge specifying module 350 calculates an absolute value of a difference value between the first horizontal edge detection pixel and the second horizontal edge detection pixel as a first absolute value, and calculates an absolute value of a difference value between the third horizontal edge detection pixel and the fourth horizontal edge detection pixel as a second absolute value. Then, the horizontal edge specifying module 350 determines whether each calculated absolute value is greater than or equal to a predetermined threshold value T_{edge} (S314).

As a result, when it is determined that the first absolute value and the second absolute value are both not greater than or equal to the threshold value (No at S314), the horizontal edge specifying module 350 performs S316 described later. On the other hand, when it is determined that the first absolute value and the second absolute value are both greater than or equal to the threshold value (Yes at S314), the horizontal edge specifying module 350 specifies the target pixel and the adjacent pixel as a horizontal edge (S315).

Then, the horizontal edge specifying module 350 determines whether all of the interpolation target pixels are selected as the target pixel (S316). When it is determined that all of the interpolation target pixels are not selected as the target pixel (No at S316), then the horizontal edge specifying module 350 repeats the processing beginning with S310. On the other hand, when it is determined that all of the interpolation target pixels are selected as the target pixel (Yes at S316), then the horizontal edge specifying module 350 ends the horizontal edge specifying processing.

After the horizontal edge specifying processing, the horizontal boundary specifying module 305 performs the horizontal boundary coordinate detection of the first embodiment. However, the horizontal boundary specifying module 305 of the present embodiment additionally determines whether the interpolation target pixel corresponding to the first motion detection signal MD_{T1} is specified as the horizontal edge, after S110 and before S111 of the horizontal boundary coordinate detection in FIG. 5. Furthermore, the horizontal boundary specifying module 305 of the present embodiment further determines whether the interpolation target pixel corresponding to the second motion detection signal MD_{T2} is specified as the horizontal edge, after S116 and before S117 of the horizontal boundary coordinate detection in FIG. 5. As a result, when the interpolation target pixel corresponding to the first motion detection signal MD_{T1} or the second motion detection signal MD_{T2} is not specified as the horizontal edge, the horizontal boundary specifying module 305 repeats the processing beginning with S110 or S116. On the other hand, when the interpolation target pixel corresponding to the first motion detection signal MD_{T1} or the second motion detection signal MD_{T2} is specified as the horizontal edge, the horizontal boundary specifying module 305 repeats the processing beginning with S111 or S117.

As described above, according to the third embodiment, it is determined whether the interpolation target pixel is specified as the horizontal edge in addition to specifying the horizontal boundary. Consequently, the horizontal boundary can be specified with high accuracy.

In the third embodiment, the horizontal edge specifying processing is performed based on the pixel P220 located spatially adjacent to the interpolation target pixel T_{A} in vertically upward direction and the pixel P221 located spatially adjacent to the interpolation target pixel T_{B} in vertically upward direction. However, the horizontal edge specifying processing may be performed based on the pixel P210 located spatially adjacent to the interpolation target pixel T_{A} in vertically downward direction and the pixel P211 located spatially adjacent to the interpolation target pixel T_{B} in vertically downward direction.

Furthermore, in the third embodiment, the target pixel and the adjacent pixel are specified as the horizontal edge when it is determined that both of the first absolute value and the second absolute value are greater than or equal to the predetermined threshold value. However, one of the target pixel and the adjacent pixel may be specified as the horizontal edge when it is determined that both of the first absolute value and the second absolute value are greater than or equal to the predetermined threshold value.

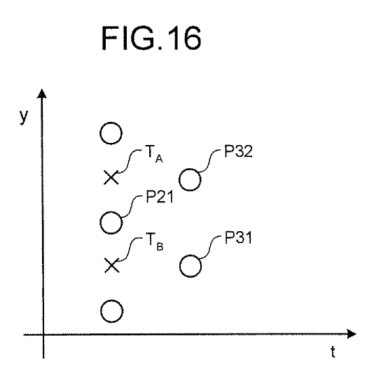

Furthermore, in the third embodiment, the horizontal edge is specified for the input video as in FIG. 2. However, a vertical edge may be specified for an input video as in FIG. 7. In this case, the signal processor may have the vertical edge detector. In the following, vertical edge specifying processing of the vertical edge specifying module is explained with reference to FIG. 16.

FIG. 16 illustrates an interpolation target pixel T_{A}, an interpolation target pixel T_{B} located spatially adjacent to the interpolation target pixel T_{A} in the downward direction, a pixel P21 located between the interpolation target pixels T_{A} and T_{B} in the vertical direction, a pixel P32 located at the same spatial position as the interpolation target pixel T_{A}, and a pixel P31 located at the same spatial position as the interpolation target pixel T_{B}. The pixel P21 is included in the current field signal P2, and the pixels P32 and P31 are included in the preceding field signal P3 of a frame that differ in time from the frame of the current field signal P2.

The vertical edge specifying module selects an interpolation target pixel such as a pixel T_{A} in FIG. 16, as a target pixel. Further, the vertical edge specifying module selects an interpolation target pixel located spatially adjacent to the target pixel in a vertical direction such as a pixel T_{B} in FIG. 16, as the adjacent pixel. Further, the vertical edge specifying module selects a pixel such as a pixel P21 in FIG. 16 located between the target pixel and the adjacent pixel from the current field signal P2, as the first vertical edge detection pixel. Further, the vertical edge specifying module selects a pixel such as a pixel P31 in FIG. 16 located at the same spatial position as that of the target pixel, as a second vertical edge detection pixel. Further, the vertical edge specifying module selects a pixel such as a pixel P32 in FIG. 16 located at the same spatial position as that of the adjacent pixel, as a third vertical edge detection pixel.

Next, the vertical edge specifying module calculates an absolute value of a difference value between the first vertical edge detection pixel and the second vertical edge detection pixel as a first absolute value. Further, the vertical edge specifying module calculates an absolute value of a difference value between the second vertical edge detection pixel and the third vertical edge detection pixel as a second absolute value. Then, the vertical edge specifying module specifies the interpolation target pixels TA and TB as the vertical edge when both of the first absolute value and the second absolute value are greater than or equal to the predetermined threshold value. Consequently, as similar to the aforementioned horizontal boundary specifying processing based on the horizontal edge, vertical boundary specifying processing can be performed only for the interpolation target pixels specified as the vertical edge; therefore, the vertical boundary specifying processing can be performed with high accuracy.

The aforementioned vertical edge specifying processing is performed based on the absolute value of the difference value between pixels P21 and P31. However, the vertical edge specifying processing may be performed based on an absolute value of a difference value between the pixels P21 and P32.

Further, in the aforementioned vertical edge specifying module, the target pixel and the adjacent pixel are specified as the vertical edge when it is determined that both of the first absolute value and the second absolute value are greater than or equal to the predetermined threshold value. However, the one of the target pixel and the adjacent pixel may be specified as the vertical edge when it is determined that both of the first absolute value and the second absolute value are greater than or equal to the threshold value.

Further, the horizontal edge specifying module and the vertical edge specifying module may be combined in accordance with input video.

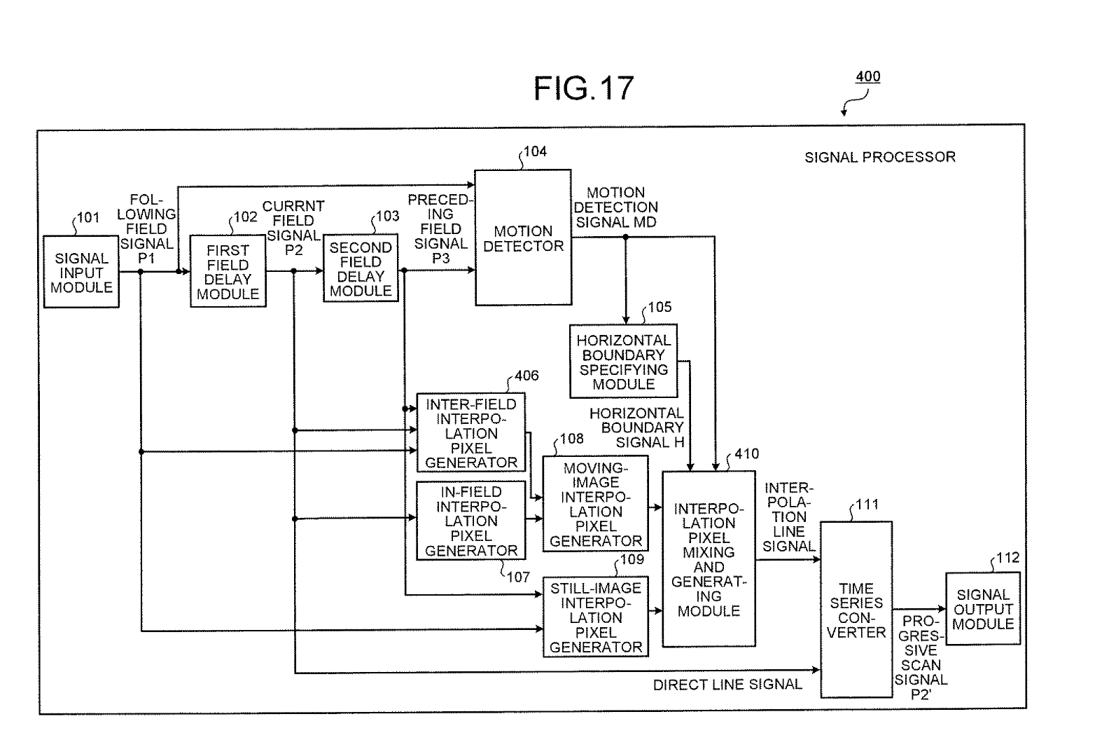

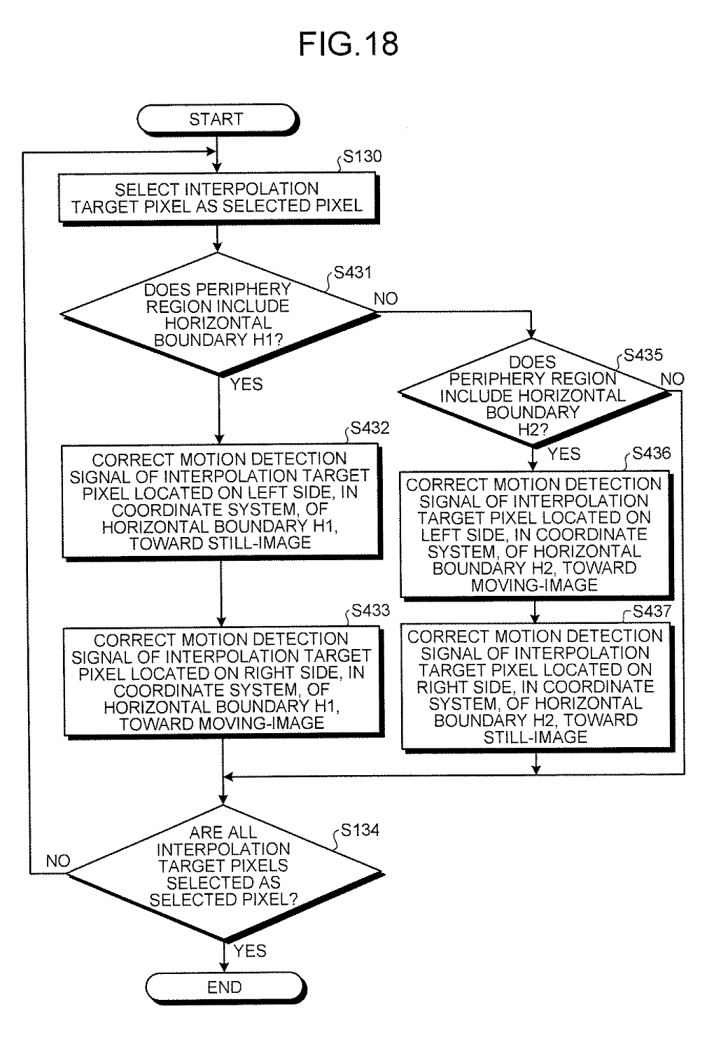

Next, a fourth embodiment of the present invention is explained with reference to FIGS. 17 and 18. A signal processor and a signal processing method of the present embodiment differs from the signal processor and the signal processing method of the first embodiment in that the horizontal boundary signal H is input to the interpolation pixel mixing and generating module instead of input to the interpolation pixel generator. Thus, the same letters and numbers are assigned for parts and elements that are similar to that of the aforementioned first embodiment, and the explanations thereof are omitted. In the present embodiment, a video as in FIG. 2 having added the side panel on both sides of the moving-image region is input to the signal processor as an input video.

FIG. 17 is a block diagram of a signal processor 400 of the present embodiment. It should be mentioned here that an inter-field interpolation pixel generator 406 does not correct motion vector, which differs from the inter-field interpolation pixel generator 106.

An interpolation pixel mixing and generating module 410 corrects the motion detection signal MD based on the horizontal boundary signal H. Further, the interpolation pixel mixing and generating module 410 mixes the moving-image interpolation pixel generated by the moving-image interpolation pixel generator 108 and the still-image interpolation target pixel generated by the still-image interpolation pixel generator 109 based on equation (1), and outputs the mixed interpolation pixel to the time series converter 111.

FIG. 18 is a flowchart of the motion detection signal correction of the interpolation pixel mixing and generating module 410. The interpolation pixel mixing and generating module 410 selects an interpolation target pixel not yet selected as a selected pixel as the selected pixel (S130). Next, the interpolation pixel mixing and generating module 410 determines whether the horizontal boundary H1 is included in a periphery region used to calculate the motion detection signal of the selected pixel via the area filtering (S431). As a result, when it is determined that the horizontal boundary H1 is included in the periphery region (Yes at S431), the interpolation pixel mixing and generating module 410 corrects motion detection signals of all of the interpolation target pixels not having performed the motion detection signal correction and located on the left side, in the coordinate system, of the horizontal boundary H1 and included in the periphery region, more towards still-image (S432). Further, the interpolation pixel mixing and generating module 410 corrects the motion detection signals of all of the interpolation target pixels not having performed the motion detection signal correction and located on the right side, in the coordinate system, of the horizontal boundary H1 and included in the periphery region, more towards moving-image (S433). Then, the interpolation pixel mixing and generating module 410 determines whether all of the interpolation target pixels are selected as the selected pixel (S134). As a result, when it is determined that all of the interpolation target pixels are not selected as the selected pixel (No at S134), the interpolation pixel mixing and generating module 410 performs S130. On the other hand, when it is determined that all of the interpolation target pixels are selected as the selected pixel, the interpolation pixel mixing and generating module 410 ends the motion detection signal correction (Yes at S134).

As a result of S431, when it is determined that the horizontal boundary H1 is not included in the periphery region (No at S431), the interpolation pixel mixing and generating module 410 determines whether the horizontal boundary H2 is included in the periphery region (S435). As a result, when it is determined that the horizontal boundary H2 is not included in the periphery region (No at S435), the interpolation pixel mixing and generating module 410 performs S134. On the other hand, when it is determined that the horizontal boundary H2 is included in the periphery region (Yes at S435), the interpolation pixel mixing and generating module 410 corrects the motion detection signals of all of the interpolation target pixels not having performed the motion detection signal correction and located on the left side, in the coordinate system, of the horizontal boundary H2 and included in the periphery region, more towards the moving-image (S436). Further, the interpolation pixel mixing and generating module 410 corrects the motion detection signals of all of the interpolation target pixels having not performed the motion detection signal correction and located on the right side, in the coordinate system, of the horizontal boundary H2 as well as included in the periphery region, more towards the still-image (S437). Then, the interpolation pixel mixing and generating module 410 performs S134.

As described above, according to the fourth embodiment, the motion detection signal used when the moving-image interpolation pixel and the still-image interpolation pixel are mixed is corrected for the interpolation target pixel near the horizontal boundary. In particular, the horizontal boundary specifying module recognizes the moving-image region and the still-image region by specifying the boundary. Then, when the interpolation target pixel near the boundary is recognized as to belong to the moving-image region, the interpolation pixel mixing and generating module corrects the inter-frame motion of the interpolation target pixel more towards the moving-image. On the other hand, when the interpolation target pixel near the boundary is recognized as to belong to the still-image region, the interpolation pixel mixing and generation module corrects the inter-frame motion of the interpolation target pixel more towards the still-image. Consequently, when the motion detection signal of the interpolation target pixel located in the still-image region near the boundary is calculated as being more towards the moving-image by the effect of the pixel located in the moving-image region in the periphery region, such motion detection signal of the interpolation target pixel can be corrected more towards the still-image. On the other hand, when the motion detection signal of the interpolation target pixel located in the moving-image region near the boundary is calculated as being more towards the still-image by the effect of the pixel located in the stilt-image region in the periphery region, such motion detection signal of the interpolation target pixel can be corrected more towards the moving-image. Hence, the moving-image interpolation pixel and the still-image interpolation pixel can be mixed with appropriate mixing ratio for the interpolation target pixels near the boundary. As a result, it becomes possible to suppress image gradation such as flicker near the boundary between the still-image region and the moving-image region in the output video.

In the fourth embodiment, only the motion detection signal is corrected based on the horizontal boundary signal. However, the motion vector may also be corrected that is used to generate the inter-field interpolation pixel.

Further, the signal processor may have a vertical boundary specifying module instead of the horizontal boundary specifying module, depending on the input video. Furthermore, the signal processor may have the horizontal edge specifying module and/or the vertical edge specifying module.

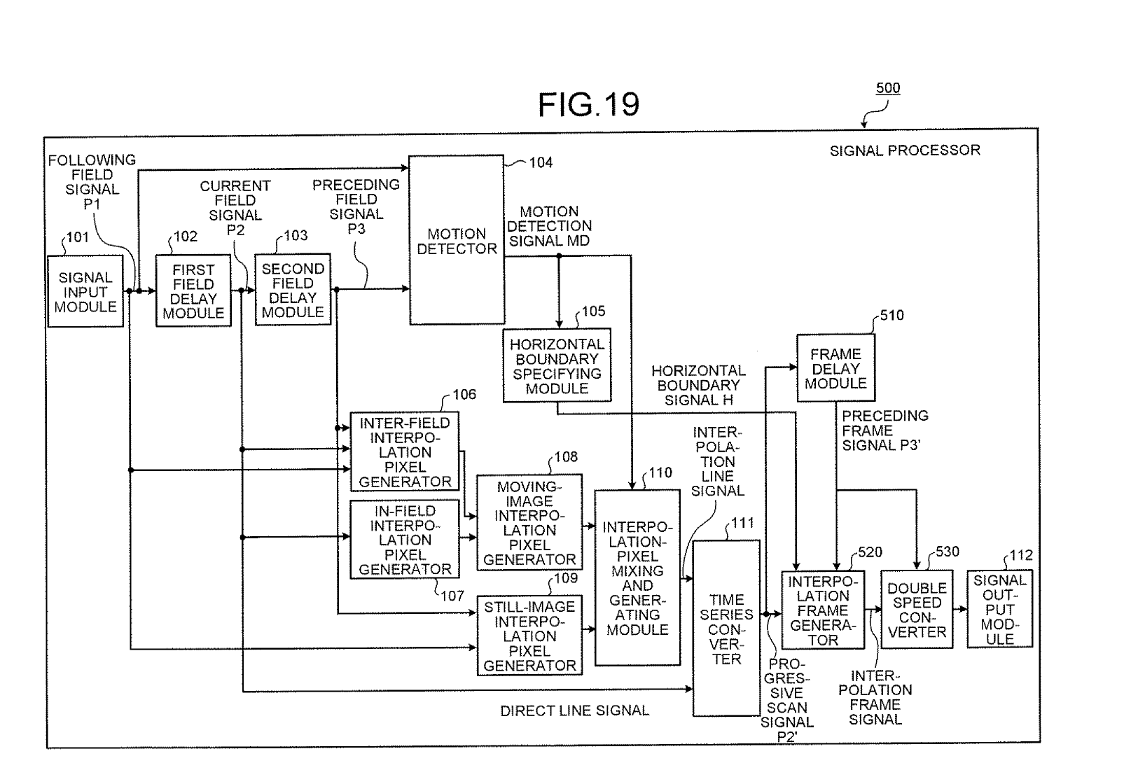

Next, a fifth embodiment of the present invention is explained with reference to FIG. 19. The same letters and numbers are assigned for parts and elements that are similar to that of the aforementioned first to fourth embodiments, and the explanations thereof are omitted. In the present embodiment, a video as in FIG. 2 having added the side panel on both sides of the moving-image region is input to the signal processor as an input video.

FIG. 19 is a block diagram of a signal processor 500 of the present embodiment. The signal processor 500 further has a frame delay module 510, an interpolation frame generator 520, and a double speed converter 530.

The frame delay module 510 delays the progressive scan signal P2′ output by the time series converter 111 by one frame to generate a preceding frame signal P3′, and output it to the interpolation frame generator 520 and the double speed converter 530.

The interpolation frame generator 520 calculates a motion vector from the progressive scan signal P2′ and the preceding frame signal P3′, corrects the calculated motion vector based on the horizontal boundary signal H, generates an interpolation frame based on the corrected motion vector, and output the generated interpolation frame to the double speed converter 530. The interpolation frame interpolates a frame the progressive scan signal is mixing when an output frequency is converted from, for example, 60 Hz to 120 Hz in the double speed converter 530. the motion vector calculation and the correction are the same as that of the first embodiment, so that the explanations thereof are omitted.

The double speed converter 530 inserts an interpolation frame signal later in time with respect to the preceding frame signal P3′ based on the preceding frame signal P3′ and the interpolation frame signal, and output those to the signal output module 112.

As described above, according to the fifth embodiment, the motion vector is appropriately corrected based on the boundary when the interpolation frame is generated based on the motion vector. That is to say, the horizontal boundary specifying module recognizes the moving-image region and the still-image region by specifying the boundary. Then, when it is recognized that the interpolation target pixel near the boundary belongs to the moving-image region, the interpolation frame generator corrects the motion vector of the interpolation target pixel more towards the moving-image. On the other hand, when it is recognized that the interpolation target pixel near the boundary belongs to the still-image region, the interpolation frame generator corrects the motion vector of the interpolation target pixel more towards the still-image. As a result, it becomes possible to suppress image degradation such as flicker near the boundary between the moving-image region and the still-image region in the output video.

In the fifth embodiment, the motion vector is corrected in the interpolation frame generator. However, the motion vector may additionally be corrected in the inter-field interpolation pixel generator, or the motion detection signal used by the interpolation pixel mixing and generating module may be correct, or all of the correction may be performed.

Further, in the fifth embodiment, the motion vector is corrected based on the horizontal boundary. However, the motion vector may be corrected based on the horizontal boundary and/or the vertical boundary.

Further, the signal processor may have the horizontal edge specifying module and/or the vertical edge specifying module, depending of the input video.

Further, the signal processor has been described above as having both of the inter-field interpolation pixel generator and the in-field interpolation pixel generator. However, the signal processor may have one of the inter-field interpolation pixel generator and the in-field interpolation pixel generator.

Further, the signal processor and the signal processing method of the first to the fifth embodiment are applied to process the interlaced scan video signal provided by the digital television broadcasting. However, the signal processor and the signal processing method may be applied to process a video signal provided through, for example, analog broadcasting, ES broadcasting, CS broadcasting, or IP broadcasting.

Further, the signal processor of the first to the fifth embodiment may be connected to any display such as LCD to display the signal output by the signal output module.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A signal processor comprising:
a signal input module configured to receive an interlaced-to-progressive following field signal of a predetermined video;
a first field delay module configured to delay the following field signal by one field to generate a current field signal;
a second field delay module configured to delay the current field signal by one field to generate a preceding field signal;
a motion detector configured to detect inter-frame motion for each interpolation target pixel based on the following field signal and the preceding field signal, the interpolation target pixel being a missing pixel within scan lines displaying the video;
a boundary specifying module configured to specify a boundary between a moving-image area and a still-image area of the video based on the inter-frame motion;
an interpolation pixel generator configured to generate an interpolation pixel that interpolates the interpolation target pixel based on the boundary and at least one of the following field signal, the current field signal, and the preceding field signal; and
an output signal generator configured to generate an output signal in which the interpolation target pixel is interpolated by the interpolation signal.

2. The signal processor of claim 1, wherein the interpolation pixel generator includes
a moving-image interpolation pixel generator configured to calculate an inter-frame motion vector based on at least two of the following field signal, the current field signal, and the preceding field signal, correct the inter-frame motion vector of the interpolation target pixel near the boundary, and generate a moving-image interpolation pixel based on the corrected inter-frame motion vector,
a still-image interpolation pixel generator configured to generate a still-image interpolation pixel based on at least one of the following field signal and the preceding field signal, and
an interpolation pixel mixing and generating module configured to mix the moving-image interpolation pixel and the still-image interpolation pixel at a predetermined ratio, and generate the interpolation pixel that interpolates the current field signal.

3. The signal processor of claim 1, wherein the interpolation pixel generator includes
a moving-image interpolation pixel generator configured to generate a moving-image interpolation pixel based on at least one of the following field signal, the current field signal, and the preceding field signal,
a still-image interpolation pixel generator configured to generate a still-image interpolation pixel based on at least one of the following field signal and the preceding field signal, and
an interpolation pixel mixing and generating module configured to correct the inter-frame motion of the interpolation target pixel near the boundary, mix the moving-image interpolation pixel and the still-image interpolation pixel based on the corrected inter-frame motion, and generate the interpolation pixel that interpolates the current field signal.

4. The signal processor of claim 1, wherein the interpolation pixel generator includes
a progressive scan signal generator configured to generate a progressive scan signal based on the current field signal,
a frame delay signal configured to delay the progressive scan signal by one frame to generate a delayed frame signal, and
an interpolation frame generator configured to calculate an inter-frame motion vector based on the progressive scan signal and the delayed frame signal, correct the inter-frame motion vector of the interpolation target pixel near the boundary, and generate the interpolation pixel that is inserted between sequential frames based on the corrected inter-frame motion vector.

5. The signal processor of claim 1, wherein, when the inter-frame motion of only one of horizontally adjacent interpolation target pixels corresponds to moving-image, the boundary specifying module specifies the interpolation target pixel as the boundary.

6. The signal processor of claim 1, wherein, when the inter-frame motion of only one of vertically adjacent interpolation target pixels corresponds to moving-image, the boundary specifying module specifies the interpolation target pixel as the boundary.

7. The signal processor of claim 1, further comprising a horizontal edge specifying module configured to calculate an absolute value of a difference value between horizontally adjacent pixels among pixels of the video, and specify the horizontally adjacent pixels as a horizontal edge when the absolute value of the difference values between the horizontally adjacent pixels is greater than or equal to a predetermined threshold value, wherein
when the inter-frame motion of only one of the horizontally adjacent interpolation target pixels corresponds to moving-image and the one of the horizontally adjacent interpolation target pixels is specified as the horizontal edge, the boundary specifying module specifies the one of the horizontally adjacent interpolation target pixels as the boundary.

8. The signal processor of claim 1, further comprising a vertical edge specifying module configured to calculates a first absolute value of a first difference value between vertically adjacent pixels and a second absolute value of a second difference value between pixels adjacent in space and time among pixels of the video, and specify the vertically adjacent pixels as a vertical edge when the first and the second absolute values are greater than or equal to a predetermined threshold value, wherein
when the inter-frame motion of only one of the vertically adjacent interpolation target pixels corresponds to moving-image and the one of the horizontally adjacent interpolation target pixels is specified as the vertical edge, the boundary specifying module specifies the one of the interpolation target pixels as the boundary.

9. The signal processor of claim 1, further comprising a display module configured to display the output signal generated by the output signal generator.

10. A signal processing method performed by a signal processor having a signal input module, a first field delay module, a second field delay module, a motion detector, a boundary specifying module, an interpolation pixel generator, and an output signal generator, the signal processing method comprising:
the signal input module receiving an interlaced to-progressive following field signal of a predetermined video;
the first field delay module delaying the following field signal by one field to generate a current field signal;
the second field delay module delaying the current field signal by one field to generate a preceding field signal;
the motion detector detecting inter-frame motion for each interpolation target pixel based on the following field signal and the preceding field signal, the interpolation target pixel being a missing pixel within scan lines displaying the video;
the boundary specifying module specifying a boundary between a moving-image area and a still-image area of the video based on the inter-frame motion;
the interpolation pixel generator generating an interpolation pixel that interpolates the interpolation target pixel based on the boundary and at least one of the following field signal, the current field signal, and the preceding field signal; and
the output signal generator generating an output signal in which the interpolation target pixel is interpolated by the interpolation signal.
